(19) United States
(12) Patent Application Publication
(10) Pub. No.: US 2021/0209591 A1
(43) Pub. Date: Jul. 8, 2021

(54) SYSTEM FOR NOTIFYING A MERCHANT AFTER COMPLETION OF A PREVIOUS TRANSACTION BY THE MERCHANT WHEN A PAYMENT INSTRUMENT USED FOR THE PREVIOUS TRANSACTION HAS BEEN IDENTIFIED AS BEING SUSPECT

(71) Applicant: Gravic, Inc., Malvern, PA (US)

(72) Inventors: Bruce D. HOLENSTEIN, Media, PA (US); Dylan R. HOLENSTEIN, Media, PA (US); Paul J. HOLENSTEIN, Downingtown, PA (US); Wilbur H. HIGHLEYMAN, Blairstown, NJ (US)

(21) Appl. No.: 17/212,203

(22) Filed: Mar. 25, 2021

Related U.S. Application Data
(63) Continuation of application No. 13/752,967, filed on Jan. 29, 2013, now abandoned.

(51) Int. Cl. G06Q 20/38; G06Q 20/40

(52) U.S. Cl. CPC G06Q 20/3827; G06Q 20/4016; G06Q 20/382

(57) ABSTRACT

A system is provided for notifying a merchant after completion of a previous transaction by the merchant when a payment instrument used for the previous transaction has been identified as being suspect as a result of suspect activity regarding the payment instrument that is unrelated to the previous transaction. The notification is in the form of an electronically issued dispute or deactivation notification regarding any suspect payment instrument indicia that matches payment instrument indicia used for a transaction previously completed by the merchant.

### CROSS-REFERENCE TO RELATED APPLICATIONS

This application is a continuation of copending U.S. application Ser. No. 13/752,967 filed Jan. 29, 2013, which is incorporated by reference herein.

### BACKGROUND OF THE INVENTION

Credit cards and debit cards have become the predominant form of payment for both in-store and online shoppers. Credit cards provide a revolving credit line to the cardholder. Debit cards provide a direct transfer of money from the cardholder's bank account. Credit cards and debit cards can be used today to purchase products from most merchants.

### A History of Credit Cards

The concept of credit cards started with charge cards. In the 1920s, fuel companies issued charge cards that allowed their customers to purchase fuel for their automobiles. The airlines adopted charge cards in the 1930s. A charge card had to be paid in full every month and could only be used for products sold by the issuing company.

In 1950, Diners Club was founded to consolidate multiple cards. With a Diners Club card, a consumer could charge products purchased from any participating vendor. Diners Club was followed by Carte Blanche and in 1958 by American Express, which created a worldwide charge card.

Up until this time, except for a few merchant-specific charge cards, there was no card with a revolving credit line that allowed customers to pay their card charges over a period of time. In 1958, Bank of America launched its BankAmericard, which became the first successful, modern-day credit card with a revolving credit line and evolved into today's VISA system.

In 1966, the ancestor of MasterCard was created when a group of banks established Master Charge to compete with Bank of America.

Today, credit cards are issued by member banks of a credit-card association (American Express acts as its own bank). These banks are known as credit-card issuers. It is the responsibility of the issuer to evaluate each customer's credit history and to set the terms of the credit line, such as the interest rate, the credit limit, and late-payment and overdraft charges. Once the credit card is issued, the cardholder can use the card's credit line to purchase products from merchants accepting the card and to take cash advances.

As part of the credit-card contract, the cardholder agrees to pay the card issuer a minimum monthly payment that includes a portion of the unpaid balance and interest on that balance. It is the issuer that assumes the credit risk if the consumer defaults on payments.

### A History of Debit Cards

Credit cards paved the way for debit cards. The first debit card was issued by Seattle's First National Bank in 1978. In 1984, Landmark created the first nationwide debit-card system using ATMs and other financial transaction networks.

As ATMs started to be deployed in the 1980s and 1990s, the use of debit cards grew accordingly. In 1990, debit cards were used in 300,000 transactions. In 1998, debit-card transactions outnumbered the use of checks. By 2009, debit cards and prepaid cards were used in over 37 billion transactions. Today, when a cardholder makes a purchase with his debit card, his bank account is immediately debited for the amount of the purchase; and the merchant's account is similarly credited. For many, the debit card has taken the place of checks and cash for purchases.

Debit cards are more convenient to use than checks and are safer than cash. Banks can stop fraudulent purchases, and customers are not held liable for purchases when a debit card is reported stolen.

However, debit cards do not provide the security of credit cards. While the holder of a credit card is legally responsible for only a minimal amount of a fraudulent transaction, which is often waived by the issuing bank, a debit-card holder must report a fraudulent transaction in a very short time period (often within two days) or be held liable for hundreds of dollars or even the full amount of the transaction. Even worse, a thief who obtains or clones a debit card along with its PIN may be able to clean out the consumer's bank account; and the consumer may have no recourse.

### Merchant Accounts

A merchant account allows businesses to accept payments by debit cards or credit cards. In order to accept such cards, a merchant must establish a merchant account. This can be done directly with a bank (the acquirer) that is a member of one or more credit-card associations or with an Independent Sales Organization (ISO) that represents one or more acquirers.

The merchant generally installs one or more point-of-sale (POS) devices to transmit the details of card transactions over a transaction-authorization network to the issuing bank for authorization. The POS devices are provided by the acquiring bank or ISO with which the merchant established its merchant account.

### Card Transactions

A credit card allows a cardholder to purchase products or services from a merchant by using the revolving credit line provided by the credit card issuer. A debit card allows a cardholder to purchase products via a direct withdrawal from his bank account. For each purchase, the merchant is charged a transaction fee for the service (an interchange fee) by the issuing bank and the credit-card association. The transaction fee is often a percentage of the transaction amount plus a fixed fee and typically ranges from one to six percent of the transaction. There is typically a delay before the merchant receives its portion of the payment.

### Transaction Authorization

Key to the success of credit cards and debit cards is the assurance that the transaction is valid. This requires that the person who is making the transaction is, in fact, the cardholder, that the card is active, and that the card's credit limit is not being exceeded (though transactions that exceed the credit limit are often authorized and a penalty is imposed on the cardholder).

### Card-Present Transactions

In a card-present transaction, card purchases are made by the cardholder physically submitting his card to the merchant at the point of sale.

In the early days of credit cards, a manual device was used to imprint the embossed card information (card number, cardholder name, card expiration date) onto a multi-part paper form that the cardholder signed. It was the responsibility of the merchant to seek identification of the person submitting the card and to use an Automated Response Unit provided by the acquiring bank or ISO to enter the transaction details in order to verify the validity of the transaction. The imprinted transaction slips were mailed or delivered to the acquiring bank or ISO at the end of each day for processing, and the merchant was typically paid according to its contract with the acquiring bank or ISO.

Manual imprinting devices have been mostly replaced with electronic POS devices. Credit cards and debit cards record the card information in a magnetic stripe or in a chip embedded in the card. This information is read by the POS device, the transaction amount is entered, and the resulting transaction detail is sent to the issuing bank for authorization or rejection. Upon authorization, a receipt in two parts is printed. One is signed by the cardholder for the merchant's records, and one is given to the cardholder for his records.

Cards have an area on the back of the card for the cardholder to sign so that his signature can be verified. Furthermore, it is still the responsibility of the merchant to further verify the cardholder's identity by perhaps asking for further identification such as a driver's license. However, to smooth the customer experience, many merchants do not check the signature, do not ask for additional identification, and do not require the cardholder to sign a transaction receipt for smaller transaction amounts. These merchants have determined that the additional sales they may make by improving transaction efficiency for the cardholder is worth the risk of not being paid for an invalid transaction.

### Card-Not-Present Transactions

As cards became an accepted and popular form of payment, merchants began to accept card payments by mail and by telephone. With the explosion of the Internet, online stores now accept cards with information entered by the cardholder via his browser. In fact, online shopping is rapidly becoming more popular than brick-and-mortar shopping in physical stores.

In a card-not-present (CNP) transaction, the merchant does not have physical access to the card. This complicates the transaction-authorization process. To ensure that the purchaser is the proper cardholder, additional information that is known to the issuer is often required. To verify that the purchaser has physical possession of the card, the card's expiration date is required. Furthermore, cards have a three- or four-digit validation code, imprinted on the front or back, that must be entered.

However, a fraudulent purchaser may have physical access of the card or may have this information derived from other sources (for instance, a restaurant waiter may copy the card information out of sight of the cardholder). Therefore, CNP transactions often require that the cardholder's billing address also be provided, as this is known by the issuing bank but presumably not by a fraudulent cardholder.

### Electronic Verification

Electronic verification systems allow merchants to immediately verify that the payment method for the purchase is valid, thereby allowing the verification to happen at the time of purchase.

In order for a credit-card transaction to be authorized, the transaction details must be sent to the issuing bank for approval. These details have been collected by the acquiring bank typically via a POS device operated by the merchant or online via the merchant's web site. Transaction-authorization networks allow merchants to verify in a few seconds that the card is valid and that the credit-card customer has sufficient credit to cover the purchase. This allows the approval to happen at the time of purchase. It is the task of the transaction-authorization network to transfer transaction requests and responses between the acquiring banks and the issuing banks, as shown in FIG. 1.

A transaction may be created in a number of ways. A card may be swiped via a POS device at the merchant's location. A clerk may enter the transaction information from a telephone order or a mail order. The cardholder may enter the information via his browser for an online order.

Whatever the method, the transaction detail is sent to the acquiring bank (1). The acquiring bank sends the transaction information to the issuing bank via a transaction-authorization network. Several such networks are operated by different entities. Examples are those provided by Visa, MasterCard, American Express (AMEX), STAR, and PULSE.

The first six digits of the credit-card number identify the issuing bank. It is the responsibility of the transaction-authorization network to receive a transaction request from an acquiring bank (2), to identify the issuing bank based on the first six digits of the credit-card number, and to send the transaction to the issuing bank (3).

The issuing bank will determine if the transaction is valid. There are several tests made on the transaction, including whether the card exists and is active, whether the associated security data is correct, and whether the transaction falls within the card's credit limit. If the transaction is valid, the issuer returns an authorization response with an approval code to the transaction-authorization network (4). Otherwise, the issuer returns a rejection response. For valid responses, the issuing bank reserves the amount of the transaction in the cardholder's account for later transfer to the acquiring bank.

The issuing bank's response is returned via the transaction-authorization network to the acquiring bank (5) and thence to the POS device or other transaction-entry mechanism (6). If the issuing bank has authorized the transaction, the transaction is accepted.

### Transaction Interchange

The flow of information and monies between the parties for clearing and settlement is known as the interchange. The settlement of monies is always accomplished through a credit-card association such as Visa, MasterCard, or American Express.

The steps involved in the interchange are shown in FIG. 2 and are as follows:
Authorization: The cardholder presents the card as payment to the merchant, and the merchant submits it for approval by the issuing bank, as described above.
Batching: Authorized transactions are stored in batches and are sent periodically by the merchant to its acquiring bank, typically once per day at the end of the business day (21).
Clearing and Settlement: The acquirer sends the batch transactions to the pertinent credit-card associations (Visa, MasterCard, etc.) (22). The credit-card associations debit the issuers (23) and credit the acquirers (24) for the transactions. Essentially, the issuer pays the acquirer for the transaction.
Funding: Following settlement, the acquiring bank pays the merchant for the transactions less the fees that the merchant pays the acquirer for processing the transactions (25).
Billing: Periodically, typically each month, the credit-card holder is sent a statement by his issuer indicating the purchases made with his card, any fees and interest, and the total amount owed (26). The cardholder pays his issuer the amount billed on the statement (or at least a minimum payment required by the issuer) (27).
Chargebacks: The cardholder may dispute with his issuer any charges that he/she (referred to hereafter, as “he”) thinks are incorrect. This may happen, for instance, after receiving his statement, after checking his account status online, upon notification (i.e., becomes alerted) by the credit-card company of a suspicious transaction, upon dissatisfaction with the product or service, or upon reporting a lost or stolen card. In the case of a dispute, the issuer requests the acquirer to settle the dispute (28). If the dispute is decided in favor of the cardholder, the acquirer forwards the chargeback to the merchant, who must either accept the chargeback or contest it.

### Credit-Card Fraud

Credit-card companies generally guarantee that the merchant will be paid for legitimate transactions regardless of whether the consumer pays his credit-card bill. However, when a card is compromised, card issuers will refund some or all of the charges that the customer has received for things he did not buy. These refunds will generally be at the expense of the merchant, especially in mail order, telephone, or online purchases where the merchant cannot claim sight of the card.

A fraud begins when a card is lost or stolen or when the data on the card is compromised. The compromising of card data can occur through many routes without the knowledge of the cardholder. Compromise techniques range from large-scale hacking of computer databases in order to access data from millions of cards to the restaurant waiter copying the data from a single card. The cardholder is generally unaware of the compromise until the account is used fraudulently. Whatever the path, the result is the exposure of the cardholder to fraudulent transactions.

Stolen or lost cards can often be reported quickly by cardholders. Most credit-card issuers provide a toll-free telephone number to report a lost or stolen card. If the report is made within a certain time after the cardholder knows about it, the liability of the cardholder is often limited. However, a compromised account can be hoarded for weeks or months before any fraudulent use is made of it, making it difficult to identify the source of the compromise. The cardholder may not discover the fraudulent activity until he receives a billing statement and has a chance to review it.

In the United States, for instance, the cardholder's responsibility for fraudulent transactions made by a lost or stolen card is limited to $50 if the loss of the card is reported within 60 days. In the case of a compromised card, the cardholder has no responsibility to the issuer for any fraudulent activity.

Internet, mail-order, and telephone-order merchants bear the broadest exposure to credit-card fraud. One technique used by CNP merchants is to ship only to a delivery address previously approved by the cardholder. However, even this address can be changed by a fraudulent user who has enough card information. Moreover, a merchant that is selling services or software products that can be delivered via the Internet cannot even take advantage of this technique.

### Verification

The credit-card companies are attempting to create a securer environment for online merchants by creating an additional authentication step that the cardholder must pass in order for his transaction to be accepted. However, since the service makes online ordering more cumbersome, the merchant must make a tradeoff between making a sale easy and faster or making it secure and slower.

In general, this additional authentication requires that the cardholder register with his issuing bank certain contact information that can be used by the merchant to send the cardholder a verification message. The contact information may be, for instance, a telephone number, an email address, or a cell-phone number for receiving SMS (Short Messaging Service) or MMS (Multimedia Messaging Service) messages.

The Verification method is shown in FIG. 3. When a cardholder initiates a purchase from the merchant (31), the merchant holds the transaction data and does not immediately submit it for authorization. Rather, the merchant, via the online or telephone purchasing session, notifies the customer to look for a message sent to him over his contact medium (for instance, telephone, email, or cell phone) to which he must respond to release the transaction.

The merchant then makes a request to the issuing bank for the contact-verification information (32). The issuer will return this information to the merchant (33), and the merchant will send a confirming message to the cardholder (34) via his contact medium. The message will generally summarize the order and will ask that the customer confirm it. For instance, it might ask the customer to click on one of two links in an email message to either confirm the order or to reject it. Alternatively, the customer may be asked to press certain keys on his telephone or to respond with a text message from his cell phone. As yet another alternate, the merchant presents questions to ask, gets the responses from the cardholder, and then sends the responses to the issuer to verify.

If the merchant receives a confirmation response (35) (which could be days later), he then enters the transaction for authorization (36), (37), as described in the section “Transaction Authorization” section. If the merchant receives a rejection message, he may ignore the order or take other actions to follow up with the purchaser.

Alternatively, the issuing bank can use this method to contact the purchaser directly to confirm his identity before providing purchase authorization to the merchant.

Unfortunately, these additional authentication steps are not absolutely secure. For instance, if a hacker should get the cardholder contact information along with the card data, the card is compromised. The hacker could use this information to go to the issuer and change the contact information so that the hacker could confirm the purchase.

### Verification Logical Flow

A flow chart showing the logical flow of the Verification method is shown in FIG. 4. When the cardholder initiates a purchase, the merchant records the potential purchase (400). The cardholder is notified that he will need to respond to a verification message (410). For instance, if the purchase is a telephone purchase, the cardholder can be told directly. If it is an online purchase, the web site can notify the cardholder. If it is a mail order, the promotional piece soliciting the order can indicate that a verification message will be forthcoming. The merchant does not know how the verification message will be sent; but the cardholder knows since he is the one that has registered contact information with the issuing bank. At this point, the potential purchase is on hold.

The merchant will request the contact information from the issuing bank (420). Upon receipt of this information (430), the merchant will send the cardholder a verification message with the details of the purchase and will request a response acknowledging or rejecting the purchase (440). For instance, if the contact information is a telephone number, the merchant may call the cardholder directly. Alternatively, a call may be placed by an Automated Response Unit with a recorded message asking him to provide an acknowledgement or rejection response by pressing certain keys on his telephone; or the message may give the cardholder a return telephone number to call. If the verification message is an email, the email may contain links for the cardholder to click to indicate the authorization or rejection of the purchase. If the verification message is a text message to his cell phone, he will be prompted for an appropriate response.

The merchant will then hold the purchase until it has obtained a response from the cardholder (450). If no response is received within an established time period (for instance, a few days) (460), the merchant will reject the transaction (490). If a rejection response is received (470), the merchant will reject the transaction (490).

If an acknowledgement is received from the cardholder (470), the merchant will submit the transaction to the issuing bank over a transaction-authorization network for approval (475). If the transaction is authorized (480), the merchant will process the purchase and will ship the order or provide the service (485). If the transaction is rejected by the issuing bank (480), the merchant will reject the order (490).

In either event, the cardholder will be notified as to the resulting status of his purchase (495).

### 3-D Secure

3-D Secure is one such service developed by Visa and offered to merchants as the Verified by Visa service. MasterCard has also adopted this service under the name MasterCard SecureCode. The authentication protocol is based on a three-domain model (hence the name 3-D). The domains are as follows:
i. the Acquirer Domain (the merchant and the acquiring bank to which the money is being paid).
ii. the Issuer Domain (the bank that issued the card being used).
iii. the Interoperability Domain (the infrastructure provided by the credit-card association to implement the 3-D protocol).

The issuing bank generally uses a third-party to provide the 3-D Secure authentication service. As part of the online processing of the transaction, the cardholder is redirected to the authentication service's web site and is requested to enter via a popup window a password known only to the issuer. Alternatively, the cardholder may be asked to respond to a challenge, the answer to which is known to the issuer (such as “What is your mother's maiden name?”). The authentication service confirms the password or challenge response with the issuer, and the cardholder is then redirected back to the merchant's web site by the authentication service to complete the transaction.

One significant disadvantage of this service is that the cardholder sees his browser connect to an unfamiliar web site. He does not know if this is the proper web site or a fraudulent web site set up to harvest secret passwords since the proper web site is not the merchant's site, the issuer's site, or the credit-card association's site. The web site is that of the 3-D Secure service provider of which the cardholder has no knowledge.

As a consequence of this problem coupled with the extra step required of the cardholder, security services such as 3-D Secure for online merchants have not yet been widely adopted by merchants.

### Chargebacks

A chargeback is the return of funds to a cardholder or bank (or cancellation of payment to merchant) at the expense of the merchant. It is forcibly initiated by the issuing bank of the card used by the cardholder following a dispute by the cardholder or upon determination by the bank or another party of a fraudulent transaction.

The chargeback mechanism exists primarily for consumer protection. A chargeback is usually initiated when a cardholder contacts his issuing bank and disputes one or more items on his statement. They may be items that he claims he never purchased, that he never received, or that were faulty upon receipt. Complaints also arise when the cardholder forgets that he made the purchase or doesn't recognize the charge. Cardholders may also fraudulently initiate a dispute to reverse the charges for a valid transaction.

The issuing bank submits the chargeback request with a reason code to the acquiring bank. The acquiring bank works with the merchant to attempt to resolve the dispute to the customer's satisfaction.

Many disputes are resolved by the acquirer returning additional detail of the transaction to the issuing bank and cardholder. If a dispute cannot be resolved, the card companies generally rule in favor of the cardholder. This causes the disputed amount to be reversed, and monies in the amount of the transaction are debited from (or never credited to) the merchant's account.

In most cases, the merchant is also charged a chargeback fee. Not only does the merchant lose the goods or services it sold, but it also has lost the payment for the merchandise and all of the fees associated with the transaction as well as the chargeback fee. In extreme cases, the merchant can be heavily fined or lose its card privileges if it suffers too many chargebacks.

One of the most common reasons for a chargeback is a fraudulent transaction. In some cases, if the merchant can demonstrate to the acquiring bank that he has properly obtained all of the information concerning the cardholder as required by the bank, he may not be liable for the chargeback.

Many issuing banks and ISO's have sophisticated fraud-detection systems to attempt to identify fraudulent transactions and to reject them or put them on hold. However, the goal of the credit-card companies is not to eliminate fraud but to reduce it to manageable levels. Thus, fraud prevention measures are typically not used if their costs exceed the potential gains for issuing banks.

Also, fraud-prevention schemes that impose an additional burden on the cardholder are not gaining acceptance, as discussed previously in the section entitled “3-D Secure”.

Fraudulent transactions present a number of problems for a merchant. A primary problem is that the merchant may have delivered the goods and services but has received no payment for them. Even worse, it has been charged transaction fees and chargeback fees that it still must pay.

A further problem is that the merchant may have provided support or warranty services to a fraudulent purchaser, thus placing an increasing load on its service organization. This problem is aggravated by the delay in notifying the merchant of the fraudulent or disputed transaction, a delay that can be measured in days, weeks or more from the time of the transaction to the time that the merchant is notified of the chargeback. During this time, the uninformed merchant may continue to provide valuable services to the purchaser. As soon as the merchant receives notification (i.e., becomes alerted) of the chargeback, it can decide whether or not to suspend support to the purchaser. If the purchase turns out to be legitimate because the dispute had been caused by the purchaser's error (for instance, the purchaser did not recognize the source of the charge), the merchant can then continue service as soon as the dispute is resolved.

The notification/alert time includes several components. Fraudulent charges may be made as soon as a card is lost, stolen, or compromised. For a lost or stolen card, it may be days, weeks, or more before the cardholder is aware of the loss and notifies his issuer. For a compromised card, the cardholder typically will not know until he gets his next statement or checks his account status online. Suspicious charges must then be disputed. It may take more days for the issuer to notify the acquiring bank that there is a dispute and for the acquirer to contact the merchant about the dispute. Only then does the merchant know that there is a potential for a fraudulent or disputed transaction. The time from the purchase to the chargeback inquiry is known as the merchant's “fraudulent or disputed transaction exposure window.” It can easily be measured in days, weeks, or even months.

What are needed are methods that reduce or eliminate the time that a merchant is exposed to a fraudulent or disputed transaction as a result of a chargeback.

### BRIEF SUMMARY OF THE INVENTION

It is the purpose of this invention to reduce or eliminate the time that a merchant is exposed to a fraudulent or disputed transaction. Two methods are disclosed—the Dispute or Deactivation Notification method and the Dispute or Deactivation Query method.

The Dispute or Deactivation Notification method provides a means to notify the merchant as soon as a card that it has accepted for a purchase is deactivated or the charge is being disputed. Among the reasons that a card may be deactivated or charge disputed is that a cardholder notifies his issuing bank that he no longer has possession of his card or that he has on his billing statement a transaction that he did not make. In accordance with this method, a log of deactivated cards and disputed transactions is maintained by the credit-card association or by some other entity. When the merchant accepts a card for a purchase, it registers the card with the entity maintaining the deactivated card log. Should the card be deactivated later, the logging entity will notify the merchant about the card deactivation. At this point, the merchant can decide whether to ship the product or to provide support for the product during the dispute phase. This significantly narrows the exposure window for the merchant.

A variation of this method is for the card issuer to provide the dispute or deactivation notification to the merchant when the issuer deactivates a card. The issuer can scan its own database to find the transactions that were made to the deactivated card, or that are being identified as fraudulent or disputed, following its deactivation and use this information to determine which merchants should get the deactivation notification/alert. Alternatively, when it deactivates a card, the issuer could use the merchant-registration database as described above to determine the merchants to notify.

A further variation of this method is for the financial transaction network provider or other servicer to be made aware of a card deactivation and to scan its own logs or the third-party merchant-registration database to determine which merchants it should notify about the deactivation.

The Dispute or Deactivation Query method allows a merchant who has accepted a card for a previous purchase to verify that the card is still active before providing additional services as part of the original transaction.

Though these methods provide protection to a merchant for CNP purchases, they also are applicable to card present (CP) purchases in which the merchant is given physical access to the card. They reduce or eliminate the merchant's problem of additional, preventable losses due to the fraudulent use of credit cards and debit cards and subsequent provision and delivery of additional products and services after the charge has been disputed.

Methods are thus provided for reducing the merchant chargeback notification time. More specifically, a method is provided of alerting a merchant after completion of a transaction that the payment instrument used for the transaction has been identified as being suspect. A reporting processor receives payment instrument indicia regarding payment instruments which have been used for completion of transactions by the merchant, and payment instrument indicia regarding payment instruments which have been identified as being suspect. The reporting processor compares the payment instrument indicia which have been used for completion of transactions by the merchant with the payment instrument indicia which have been identified as being suspect to identify matching payment instrument indicia. The matching payment instrument indicia is associated with suspect payment instrument indicia used by the merchant for completion of the transaction. An electronic communication is provided to the merchant regarding any identified suspect payment instrument indicia. In this manner, the merchant can automatically suspend delivery of a good or service associated with the transaction if payment is suspect.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, the drawings show presently preferred embodiments. However, the invention is not limited to the precise arrangements and instrumentalities shown. In the drawings:

FIG. 1 (Transaction Authorization) shows the prior art steps involved in a merchant obtaining a purchase authorization from an issuing bank.

FIG. 2 (Transaction Interchange) shows the prior art steps involved in settling credit-card transactions at the end of the day.

FIG. 3 (Verification Method) shows a prior art verification means for the merchant to verify the identity of the purchaser by sending a confirmation message to the purchaser's registered email address or other contact information before processing the transaction.

FIG. 4 (Verification Flow Chart) shows the logical flow of the prior art Verification method.

FIG. 5 (Dispute or Deactivation Notification/Query System) shows a system in accordance one preferred embodiment of the present invention for reducing the time that a merchant may have to support a fraudulent or disputed purchase by notifying the merchant as soon as a card is deactivated, or the charge is disputed.

FIG. 6 (Dispute or Deactivation Notification/Query Flowchart) shows the logical flow of the Dispute or Deactivation Notification and Dispute or Deactivation Query system of FIG. 5.

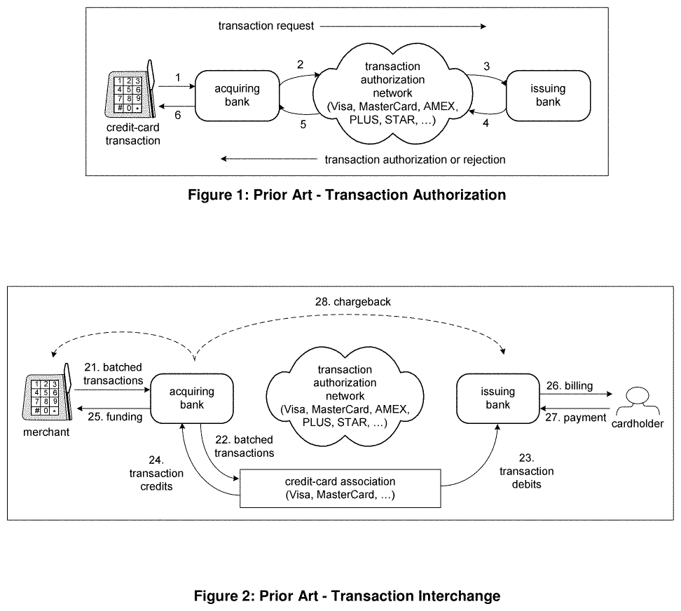

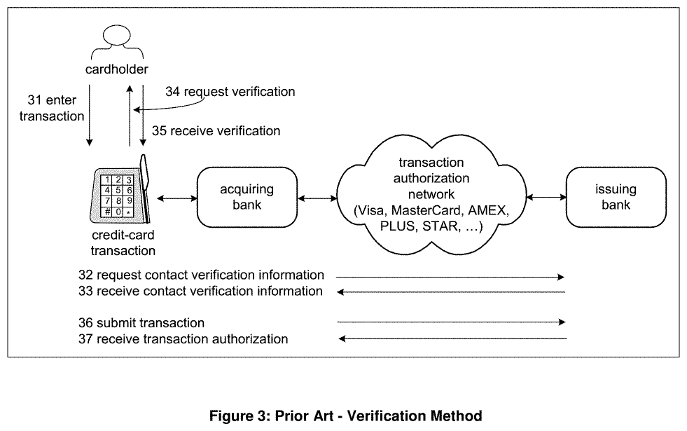

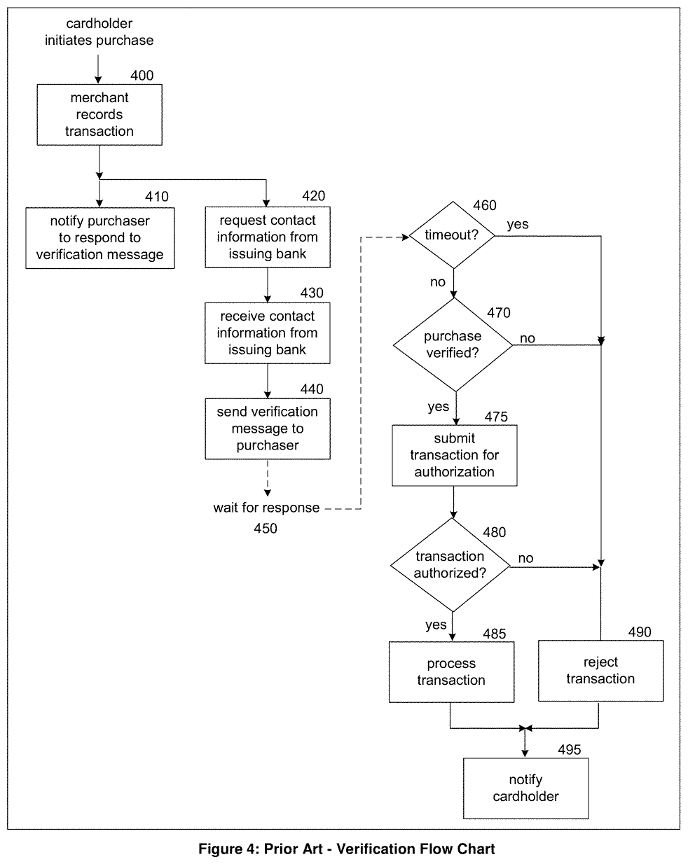

### DETAILED DESCRIPTION OF THE INVENTION

Certain terminology is used herein for convenience only and is not to be taken as a limitation on the present invention.

The following are definitions of terms used in this specification. They are hierarchically ordered in that each definition builds on previous definitions.

Credit card—a payment card issued to a user as a system of payment. It provides a revolving line-of-credit that allows the cardholder to purchase goods and services based on his promise to pay for them.

Debit card—a payment card that allows the cardholder to make payments directly from his bank account. Equivalent to writing a check. Debit-card transactions generally require the entry of a personal identification number (PIN) by the cardholder at the point of purchase to verify that the individual making the purchase is, indeed, the cardholder.

Gift card—a payment card that is the equivalent of cash. A gift card is issued by a retailer or other establishment, a credit-card company, or a bank; and the funds reflected by the gift card are on deposit with the issuer. Retailer-issued gift cards are often restricted to the purchases of goods or services from the issuing retailer. Gift cards are typically not issued in the name of any individual and are usable by any person who has possession of the card.

Stored-value card—a payment card that has recorded on it a sum of money on deposit with an issuer and that can be used as cash. Often, a stored-value card can be recharged with additional funds. Stored-value cards are usually anonymous and can typically be used by any individual in possession of the card.

Payment instrument—a credit card, a debit card, a gift card, a stored-value card, or other type of related payment device. Also, referred to herein as a “card.”

Cardholder—The holder of the card used to make a purchase.

Merchant—The individual or business accepting card payments for products or services sold to the cardholder.

Issuing bank (issuer)—The financial institution or other organization that issued the card to the cardholder.

Acquiring bank (acquirer)—The financial institution accepting payment for the products or services on behalf of the merchant.

Primary Account Number (PAN)—The card account number (usually, but not always, a sixteen-digit number with the first six digits identifying the issuing bank and the final digit being a check digit).

Independent Sales Organization (ISO)—Resellers to merchants of the services of one or more acquirers.

Merchant account—A type of bank account that allows businesses to accept payments by card. A merchant account is established with an acquirer or an ISO.

Credit-card association—An association of card-issuing banks, such as Discover, Visa, MasterCard, or American Express, that sets transaction terms for merchants, issuing banks, and acquiring banks.

Transaction—A purchase or cash advance made using a card.

Transaction authorization network—A system implementing an electronic transaction network that connects acquiring banks with issuing banks. Examples include VisaNet®, MasterCard®, AMEX®, Discover® Network, NETS/eNETS, PLUS®, PULSE®, STAR®, and INTERLINK®.

Interchange—The flow of information and monies required for clearing and settlement between parties involved in card transactions, typically performed at the end of the day.

Point-of-Sale Terminal (POS device)—a stand-alone electronic device that allows a merchant to swipe or key-enter a card's information as well as additional information required to process a card transaction.

Card-present transaction—A card transaction made by the cardholder physically presenting his card to the merchant at the point of sale.

Card-not-present (CNP) transaction—a card transaction typically made online, by telephone, or by mail, in which the merchant does not have physical access to the card.

Validation Code—A three- or four-digit number printed on the front or back of a card and that is known only to the person in physical possession of the card to demonstrate that he is presumably in possession of the card.

Chargeback—The reversal of a card charge at the expense of the merchant.

3-D Secure—an additional security layer for online card transactions. Originally developed by Visa with the intention of improving the security of Internet payments and offered to customers as the Verified by Visa service. It has been adopted by others, including MasterCard under the name MasterCard SecureCode.

Suspect transaction—A transaction that is called into doubt by a cardholder, bank, ISO, or other entity, for example, as being fraudulent, disputed, or near a credit limit.

Suspect payment instrument—A payment instrument that was used in a suspect transaction.

Reporting processor—A service which notifies merchants of suspect and disputed transactions and deactivated payment instruments; also called herein the Dispute or Deactivation Reporting Service (DDRS).

Payment instrument indicia—Data indicating the card used for the transaction such as PAN or validation code. Payment instrument indicia may also include suspect transaction identifying information. Such indicia may also consist of a one-way hash code, encryption, or other representation of said data.

Completion of transactions—A transaction between a merchant and a cardholder consists of an exchange of products and services for a monetary payment made with a payment instrument. The transaction is considered to be complete when the payment is made. However, the products and services may be provided over a varying length of time after the completion (e.g., a one month membership to a gym).

One-way hash—A way of converting data into another representation of the data which may be unique, but once the hash is known, the original data used to generate the one-way hash is no longer obtainable.

Deactivated payment instruments—A payment instrument which has been rendered unusable for new payments often as a result of a suspect transaction having been attempted or completed on the payment instrument.

Disputed payment or transaction—A payment in which the cardholder, bank, or other entity is challenging the transaction as being a suspect transaction.

Credit limit—A maximum amount of credit or value assigned to a payment instrument.

Alert or Notification—An email message, text message, TCP/IP message, printed letter, phone call, or other prompt and timely conveyance of information from one party (or automated process) to another.

### Overview

Two related methods are described in the following disclosure for reducing the fraudulent transaction exposure window for the merchant, the Dispute or Deactivation Notification method and the Dispute or Deactivation Query method. Both methods significantly reduce the notification (e.g., alert) time frame for the merchant so that its support, warranty, subsequent shipments of product, and other follow-on costs are contained.

### Dispute or Deactivation Notification

The first method of this invention reduces the time from when a fraudulent or disputed purchase is made to the time that the merchant is aware of the fraudulent or disputed purchase.

There are several general cases of questionable charges that the cardholder may challenge:

1. The cardholder sees a valid charge that he does not recognize on his statement. Either he has forgotten the charge, or he does not recognize the merchant identification printed in the statement. This situation is generally resolved immediately when the cardholder calls his issuer and is given additional identifying information about the charge.
2. The cardholder sees a charge that he does not recognize on his statement even after the issuer has given him additional merchant-identifying information. In this case, the issuer generally assumes that the card may have been compromised. It will deactivate the card and send the cardholder a new card. It will dispute all questionable charges that have been made to the old card.
3. A card is lost or stolen. As soon as the cardholder realizes this, he calls his issuer to cancel the card. The issuer deactivates the card, issues a new card for the cardholder, and disputes any charges that the cardholder does not recognize after the date of loss (valid charges may have been made after the date of loss if the cardholder had multiple copies of the card).
4. The issuer has detected a suspicious transaction via its fraud detection system. The issuer may alert the cardholder and dispute all charges questioned by the cardholder.
5. The cardholder believes that the goods are defective, incomplete, never arrived at all, or for some other reason and disputes the charge.

Except for Case 1, the merchant must defend the disputed charges and may suffer chargebacks if it is unable to defend them successfully. The methods described herein apply to any situation that causes a dispute between the merchant and the cardholder.

The Dispute or Deactivation Notification method uses the fact that the card is deactivated or the transaction disputed as soon as it appears that there may have been a fraudulent or disputed charge, whether due to a lost or stolen card or to a compromised card. However, days or more can elapse from the time of card deactivation to the time that the merchant is notified of the dispute. If the merchant can be advised immediately that a card it has accepted has been deactivated, or that the transaction is being disputed, it can take immediate action to contain its losses.

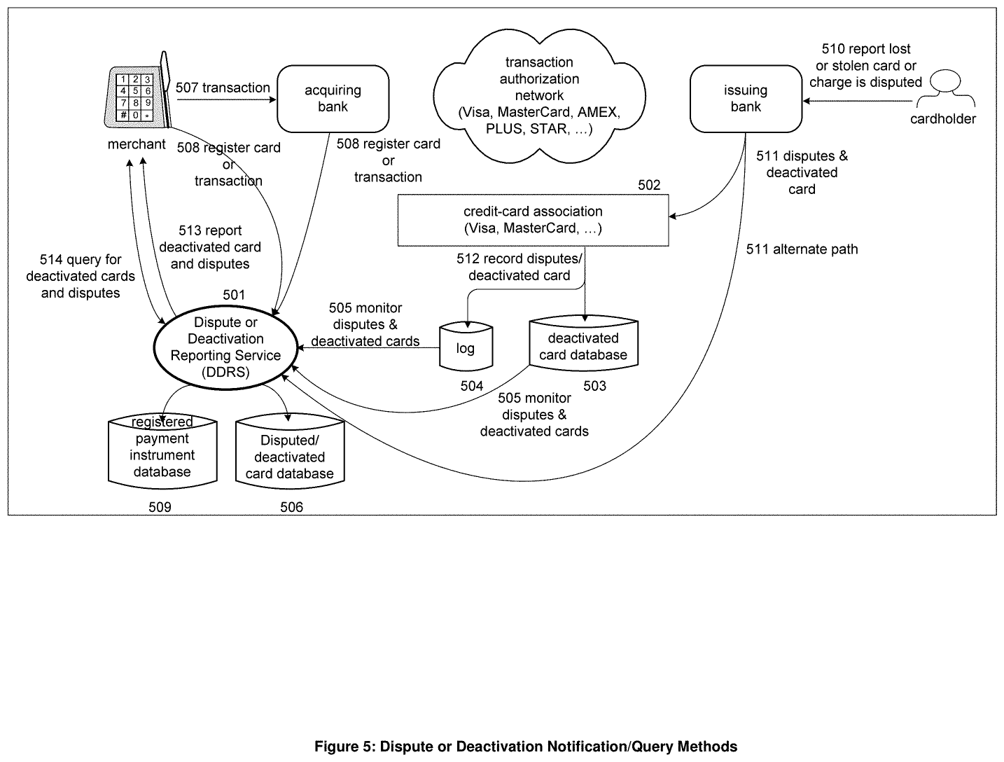

For instance, the merchant might contact the customer and obtain a statement that the transaction is valid. In this case, the merchant can use this statement to settle the dispute and can continue to provide support services. If the merchant cannot get satisfactory proof from the customer that the charge is valid, it can suspend service pending the resolution of the dispute. One approach to implement this method is shown in FIG. 5. A new service, the Dispute or Deactivation Reporting Service (DDRS), is provided to the merchant (501). This service may be offered by a credit-card association, or it may be provided by a third party in conjunction with a credit-card association. The merchant may be required to subscribe to the service and may pay fees for its use. The purpose of the service is to notify the merchant immediately upon the deactivation of a card that it has accepted for a purchase, or a dispute of one of its transactions.

DDRS requires that it have access to a database of deactivated cards, or disputed transactions, as shown in FIG. 5. If this database does not exist, the credit-card association (502) can create or foster such a database to support DDRS by receiving card-deactivation and disputed transaction notices/alerts from its issuers and by recording them in a database (503). As new entries are made to the database, they also may be entered into a sequential log that can be followed by DDRS (504). DDRS may access the logs or the databases of several credit-card associations by polling or by receiving new entries as they are entered (505) and build its own internal deactivated-card database (506).

If a cardholder attempts to make a purchase with a card that already has been deactivated (507), the transaction will be rejected in the authorization process (see “Transaction Authorization” on page 6). However, if the transaction is accepted, the acquiring bank or merchant will register the card number with DDRS (508). To provide security for the transfer of the card number to DDRS over a communication channel, the card number and transaction details may be one-way hashed or encrypted (to reduce the risk of card-number loss to hackers) and just the hash or encrypted value sent to DDRS as payment instrument indicia. DDRS will store the payment instrument indicia in its registration database (509). The registration database may also contain merchant name, acquirer name, or other specific information (such as an email address) on how the merchant will be notified or alerted.

Alternatively, the merchant can send the payment card indicia to DDRS (508). However, the merchant is not supposed to have access to the card number; so a preferred embodiment for this method is to have the acquiring bank send the card number to DDRS.

Should a cardholder report a lost or stolen card or a compromised charge to his issuer (510), the issuer will deactivate the card and will notify the credit-card association of the deactivation (511). It may also alternately directly notify the DDRS. The credit-card association will record the deactivated card number in its deactivated-card database and in its deactivated-card log (512).

Entries made to the deactivated-card log or database are forwarded to the DDRS service (505) as payment instrument indicia. This can either be an event-driven action, in which new additions are actively sent to DDRS, or DDRS can ask for deactivation additions by periodically polling the deactivated-card log or database for listed payment card indicia.

When DDRS receives a deactivated-card notice, it compares the notice to the card numbers (or hash or encrypted values thereof) that merchants have registered with it and that it has stored in its registration database. If it finds comparisons, it sends a deactivation notice to the merchants who have registered the card (513).

Alternatively, when a card is cancelled, the issuing bank can query the registrations made by merchants in the DDRS system. If any merchant has registered the card in question, the issuer can contact the merchant immediately so that it does not have to wait for a card cancellation notification.

Consequently, the merchant does not have to wait for a dispute to reach it through the banking network to know that it has accepted a potentially fraudulent or disputed transaction. It finds out about the transaction at substantially the same time as does the issuing bank and can take appropriate measures to reduce additional or future losses.

The preferred embodiment of the DDRS system is on a fault-tolerant, highly available system such as an HP® NonStop® server (computer/processor) to ensure that the service is always available to the merchants.

### Dispute or Deactivation Query

The DDRS system shown in FIG. 5 can also be used to provide the merchant with an additional level of security following a purchase if the merchant is obligated to provide follow-on services such as software support or product warranty. The problem is that a merchant may not know that a purchase is fraudulent or disputed until long after the purchase has been identified as such by the cardholder or issuing bank or other entity. It is therefore exposed to providing additional services for a purchase that will later be reversed through a chargeback.

To mitigate this possibility, the merchant may make use of the DDRS system to ensure that the card has not been deactivated or the purchase/charge disputed. Prior to providing a follow-on service, the merchant may send a Dispute or Deactivation Query request to the DDRS system with the credit-card number (514). The DDRS system will check its deactivated-card database; and if the card has been deactivated, the DDRS system will so inform the merchant.

Just because the card has been deactivated does not mean that the purchase was fraudulent or disputed. For instance, the card may have been lost or compromised and been replaced with a new card. Therefore, the merchant may take a defensive action of its choice. The merchant can contact the purchaser to verify the purchase. However, the merchant must realize that the contact information provided by the purchaser may only lead back to the dishonest purchaser if the purchase were fraudulent (the merchant is not supposed to have the true address of the cardholder). The dishonest purchaser may simply confirm the purchase.

One strategy is for the merchant to request a new credit-card number and then to make a zero-cost or one-cent transaction against that credit card to ensure that it is active. If a chargeback should later be imposed for this purchase, the credit card could be used to identify the fraudulent purchaser.

In some cases, the merchant will not have access to the credit-card number for security reasons. In this case, the acquiring bank may provide this service in the manner described above, perhaps as a service-for-fee provided by the acquirer to the merchants it services.

### Dispute or Deactivation Notification/Query Logical Flow

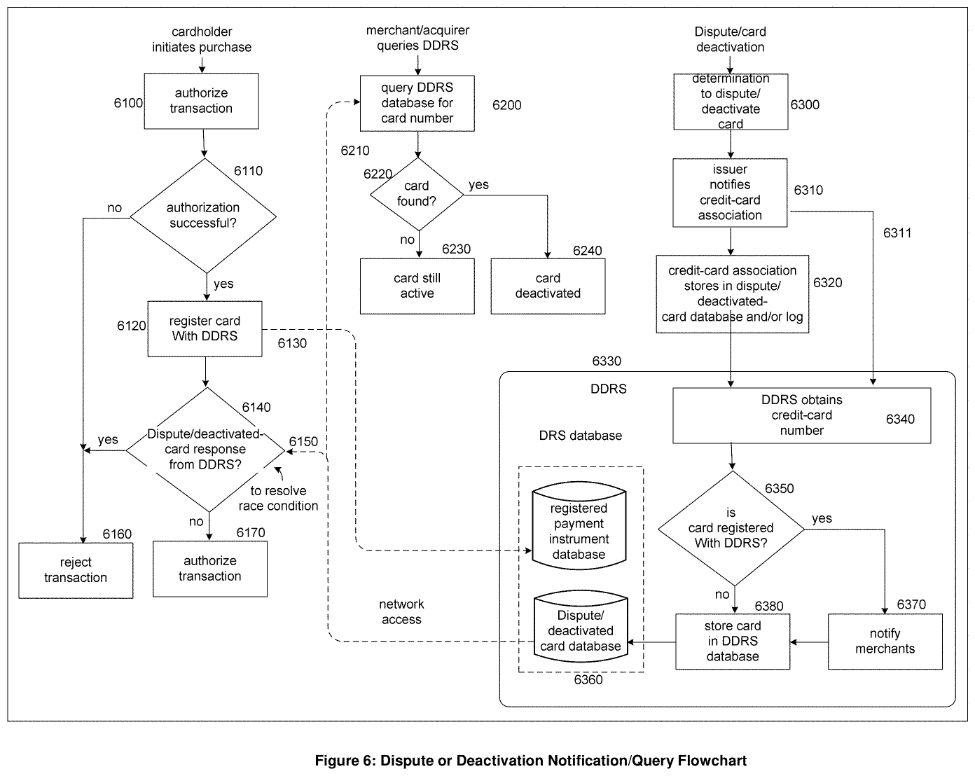

A flow chart showing the logical flow for the Dispute or Deactivation Notification and Dispute or Deactivation Query methods is shown in FIG. 6. These methods depend upon a deactivated-card database maintained by the DDRS system (6330).

### Cardholder Initiates Purchase

When a cardholder initiates a purchase, the transaction is submitted to the acquiring bank for authorization (6100). The acquiring bank will send a request to the issuing bank over a transaction-authorization network, as discussed in the section entitled “Electronic Verification”. There are several reasons why the transaction may not be authorized, including a deactivated card. If the transaction is not authorized (6110), the purchase is rejected (6160).

However, if the transaction is authorized (6110), the card is registered with DDRS (6120) over a communication network linking the acquiring bank (or merchant) to the DDRS system (6130). This causes the payment instrument indicia, e.g., card number (or its encrypted or hashed version), to be stored in the DDRS database (6360).

There is a brief window of uncertainty that must be protected against. If the card should happen to be deactivated in the brief interval from the time of authorization to the time of registration, the deactivated card will be erroneously accepted. In this case, the DDRS system will return a status indication to the registration attempt noting that the card is already in its database and should be rejected (6150). If such a notification is received (6140), the transaction will be rejected (6160). Otherwise, the transaction will be accepted (6170); and the card will be registered with the DDRS system.

### Merchant/Acquirer Queries DDRS

The merchant, the acquiring bank, or even the transaction-authorization network can check the DDRS database to see if a card has been deactivated or transaction disputed. To do this, it queries the DDRS database (6200) over the network (6210) to see if the card/transaction is in the database. If the DDRS system responds with a card not found indication (6220), the card/transaction has not been deactivated (6230).

However, if the card/transaction is in the DDRS database, it has been deactivated or disputed (6240). The merchant can take a defensive action of its choice.

### Card Deactivation/Transaction Disputed

A transaction is disputed and/or a card is typically deactivated and can no longer be used for several reasons (6300). The cardholder may report a transaction that he did not make. The cardholder can report the card to be lost or stolen. The issuing bank may detect potential fraudulent or disputed use of the card.

In any of these cases, the issuer sends a notification to the credit-card association under whose brand the card was issued and notifies the association that the card has been deactivated/transaction disputed (6310). The credit-card association typically will store the card number in its deactivated-card database (6320) and will also send the card number to the DDRS system (6330). The issuer (6310) may send a notification directly to the DDRS via alternate path (6311).

The DDRS system will receive deactivated payment instrument indicia, e.g., card number/disputed transaction details, (6340) and will check its database (6350). If a match occurs in its database, this means that one or more merchants have accepted this card for a purchase and have registered it with DDRS. In this case, DDRS will notify all of the merchants that have registered the card that the card has been deactivated (6370); and the card number will be stored in the DDRS database (6360) for future reference (6380).

If the card is not in the database (6350), no merchants have reported its use. In this case, the card number may be stored in the DDRS database (6360) for future reference (6380).

### Summary

Merchants who accept credit-card orders online, by telephone, or by mail must process the order without ever seeing the card or the cardholder. These transactions are known as cardholder-not-present, or CNP, transactions. CNP transactions significantly expand the opportunity for fraudulent or disputed transactions. Though the credit-card companies provide additional security features such as printing a verification code on the back of the card known only to the person physically in possession of the card and requesting the billing address for the card, this information is often compromised and is available to a fraudulent purchaser.

When a fraudulent or disputed transaction is discovered by the cardholder, by the issuer, or by the transaction-authorization network, the cardholder or other aforementioned party disputes the transaction. If he is successful in his dispute, the transaction is reversed; and the merchant loses the income from the sale. In addition, the merchant must often pay the credit-card transaction fees and is also generally charged a chargeback fee.

Many online sales, such as those for sophisticated software packages delivered by online downloads, may require significant follow-on technical support or product warranty work provided by the merchant. Until the merchant is notified of the dispute, the merchant may provide expensive services to a fraudulent purchaser or purchaser disputing the charge.

The two related methods of the present invention, the Dispute or Deactivation Notification and the Dispute or Deactivation Query methods, reduce the time during which a merchant may provide unwarranted support, warranty work, or extra product shipments by immediately making it aware of the dispute of the charge or deactivation of a card. At this point, it may withhold service, warranty work, or product shipment until the dispute is resolved.

The present invention may be implemented with any combination of hardware and software. If implemented as a computer-implemented apparatus, the present invention is implemented using means for performing all of the steps and functions described above.

When implemented in software, the software code can be executed on any suitable processor or collection of processors, whether provided in a single computer or distributed among multiple computers.

The present invention can also be included in an article of manufacture (e.g., one or more computer program products) having, for instance, non-transitory, tangible computer readable storage media. The storage media has computer readable program code stored therein that is encoded with instructions for execution by a processor for providing and facilitating the mechanisms of the present invention. The article of manufacture can be included as part of a computer system or sold separately.

The storage media can be any known media, such as computer memory, one or more floppy discs, compact discs, optical discs, magnetic tapes, flash memories, circuit configurations in Field Programmable Gate Arrays or other semiconductor devices, or other tangible computer storage medium. The storage media can be transportable, such that the program or programs stored thereon can be loaded onto one or more different computers or other processors to implement various aspects of the present invention as discussed above.

The computer(s) used herein may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable, mobile, or fixed electronic device.

The computer(s) may have one or more input and output devices. These devices can be used, among other things, to present a user interface. Examples of output devices that can be used to provide a user interface include printers or display screens for visual presentation of output and speakers or other sound generating devices for audible presentation of output.

Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

The terms “program” or “software” are used herein in a generic sense to refer to any type of computer code or set of computer-executable instructions that can be employed to program a computer or other processor to implement various aspects of the present invention as discussed above. The computer program need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, and the like, that perform particular tasks or implement particular abstract data types. The functionality of the program modules may be combined or distributed as desired in various embodiments.

Data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Preferred embodiments of the present invention may be implemented as methods, of which examples have been provided. The acts performed as part of the methods may be ordered in any suitable way. Accordingly, embodiments may be constructed in which acts are performed in an order different than illustrated, which may include performing some acts simultaneously, even though such acts are shown as being sequentially performed in illustrative embodiments.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A system for notifying a merchant after completion of a previous transaction by the merchant when a payment instrument used for the previous transaction has been identified as being suspect as a result of suspect activity regarding the payment instrument that is unrelated to the previous transaction, wherein the merchant has an acquiring bank, and payment instruments used for merchant transactions are from issuing banks that process chargebacks on transactions, and wherein the payment instruments have payment instrument indicia, the system comprising:
(a) a registered payment instrument database that maintains payment instrument indicia regarding payment instruments of transactions previously completed by the merchant; and
(b) an automated service configured to:
(i) receive from the merchant's payment instrument terminal, or from the merchant's acquiring bank, payment instrument indicia regarding the payment instrument which was used for completion of the previous transaction by the merchant,
(ii) store payment instrument indicia of the payment instrument which was used for completion of the previous transaction by the merchant in the registered payment instrument database,
(iii) receive from one or more transaction authorization networks, or directly or indirectly from payment instrument issuing banks, payment instrument indicia regarding payment instruments which have been identified as being suspect,
(iv) compare the payment instrument indicia regarding the payment instruments in the registered payment instrument database with the payment instrument indicia regarding payment instruments that were received from the one or more transaction authorization networks, or directly or indirectly from the payment instrument issuing banks, to identify any matching payment instrument indicia, and
(v) electronically issue a dispute or deactivation notification to the merchant for any payment instrument indicia that matches one of the payment instrument indicia in the registered payment instrument database.

2. The system of claim 1 further comprising:
(c) a merchant processor configured to receive the electronically issued dispute or deactivation notification, and automatically suspend delivery of a good or service associated with the previous transaction completed by the merchant, prior to the merchant receiving a chargeback on the previous transaction.

3. The system of claim 1 wherein the payment instrument indicia are received directly from the merchant's payment instrument terminal.

4. The system of claim 1 wherein the payment instruments which have been identified as being suspect include deactivated payment instruments.

5. The system of claim 1 wherein the payment instruments which have been identified as being suspect include payment instruments near or over their credit limit.

6. The system of claim 1 wherein the automated service is configured to perform the comparison periodically.

7. The system of claim 1 wherein the payment instrument indicia received by the automated service are received from the one or more transaction authorization networks.

8. The system of claim 1 wherein the payment instrument indicia maintained in the registered payment instrument database is an encrypted primary account number (PAN), and payment instrument indicia received from the merchant's payment instrument terminal, or from the merchant's acquiring bank, is an encrypted primary account number (PAN), and wherein the comparison performed by the automated services uses the encrypted PANs.

9. The system of claim 1 wherein the payment instrument indicia maintained in the registered payment instrument database is a one-way hash of information that includes the primary account number (PAN) of the payment instrument, and wherein the comparison performed by the automated services uses the one-way hash of information that includes the primary account number (PAN) of the payment instrument, and the payment instrument indicia received from the one or more transaction authorization networks, or directly or indirectly from the payment instrument issuing banks.
